(19) United States
(12) Patent Application Publication
(10) Pub. No.: US 2017/0042081 A1
(43) Pub. Date: Feb. 16, 2017

(54) SYSTEMS, METHODS AND APPARATUSES ASSOCIATED WITH SOIL SAMPLING

(71) Applicant: 360 YIELD CENTER, LLC, Morton, IL (US)

(72) Inventors: Lyle L. Zumbach, Cedar Rapids, IA (US); Daryl B. Starr, Lafayette, IN (US); Jonathan T. Welte, Bringhurst, IN (US); Rhett W. Schildroth, North Liberty, IA (US)

(21) Appl. No.: 15/232,139

(22) Filed: Aug. 9, 2016

Related U.S. Application Data
(60) Provisional application No. 62/203,372, filed on Aug. 10, 2015.

(51) Int. Cl. A01B 79/00; G01N 1/08

(52) U.S. Cl. CPC A01B 79/005; G01N 1/08

(57) ABSTRACT

In one aspect, a method of sampling soil is provided and includes determining a soil sampling location in a land area of interest by using, at least in part, an electronic device, displaying a first visual image associated with the soil sampling location on a display of the electronic device, navigating to the soil sampling location with the electronic device, sampling soil at the soil sampling location with a soil tester, and displaying a second visual image on the display of the electronic device associated with a result obtained from the soil sample. In one aspect, the electronic device may be a mobile electronic communication device.

### RELATED APPLICATIONS

The present application claims the priority benefit of co-pending U.S. Provisional Patent Application No. 62/203,372, filed Aug. 10, 2015, which is incorporated by reference herein.

### FIELD OF THE INVENTION

The present disclosure relates generally to agronomics and, more particularly, to systems, methods and apparatuses associated with soil sampling.

### BACKGROUND

Agricultural production can be unpredictable due to variability in relationships and patterns within a field for certain agronomic characteristics such as soil properties, topography, climate and other agronomic factors. Variability for a given crop in that field then must consider the variations within a field at a single point in time and over longer periods of time to maximize performance. Advancements in testing agronomic characteristics, through remote sensing (e.g., Unmanned Aerial Vehicles—UAVs) and on-demand soil sampling, have created the possibility to assess these agronomic characteristic variations in real or near real-time. Such management strategies have the potential to optimize crop production; however, this potential is highly dependent on the quality of the agronomic characteristic testing and the accuracy of the assessment of these variations.

One way in which agronomic characteristics are tested are through remote sensing or imagery. Remote sensing using satellites and sensors onboard an agricultural implement or a UAV can provide valuable information during critical times during the growing season.

Another way of testing agronomic characteristics is by obtaining a soil sample. The agricultural industry uses soil samples to determine the nutrient level of soil in fields. Soil sampling and testing provides an estimate of the capacity of the soil to supply adequate nutrients to meet the needs of growing crops. In some instances, the test results are compared to standard response data (e.g., ideal nitrogen levels at different growth stages) associated with specific types of crops to estimate the need to supply additional nutrients for optimum crop production. The test results are then used as a basis for profitable and environmentally responsible fertilizer application.

Soil sample analysis can be performed by sending the sample to a laboratory for analysis or using a mobile soil sampling station. When a farmer chooses laboratory analysis, he or she typically calls a soil sampling company to perform the laborious and time-consuming job of obtaining the soil samples. A soil sampler uses a soil probe to take the soil sample and the soil is then placed in a container which is sent to a lab for soil analysis. The soil samplers then identify the container to distinguish it from other containers, often by handwriting specific information on each container or by applying a pre-made label to the sample. When the soil sampler is done collecting the samples, they are shipped off to the lab where the samples can be processed and fertilizer recommendations can be made. As can be imagined, this process can take some time and generally requires the soil sampling company to maintain an office in the general geographic location in which the field is located. Furthermore, this testing procedure is prone to error resulting from mislabeling containers or mixing-up containers or test results at some point prior to reporting fertilizer recommendations.

Alternatively, if a farmer has a mobile soil sampling station, he or she can typically bring the station to field, collect the samples, test the samples and obtain the desired results immediately. This has the advantage of dramatically reducing the time required and giving the farmer near real-time actionable information to make a decision. Moreover, the farmer is certain the soil samples are accurately associated with certain fields or agricultural areas since he/she took the samples themselves. This near real time data may allow the farmer to take advantage of good weather or to ameliorate, or even altogether prevent, certain crop conditions, which left untreated, could impact yields.

Regardless of whether the farmer is using laboratory analysis or a mobile soil station, determining the correct soil sampling locations within a field or other land area of interest is problematic. The soil sampler must take a sample from a given field which adequately represents the field. However, fields are not uniform. They vary, at least, in soil type and topography such as slope.

Due to costs and the time consuming nature of the work, a farmer will typically hire a third party to test agronomic characteristics through soil sampling or remote sensing. The third party collects the soil samples and remotely sensed data and sends them to a lab for further analysis. The work is very time consuming, thereby motivating a third party or farmer to cut corners by not getting enough test samples or not getting the test samples from correct locations. For example, with respect to soil sampling, samples tend to be obtained from locations based on convenience (e.g., to avoid walking long distances through tall corn or muddy fields), user intuition or past experiences. Other times, when a grid system may be utilized for soil sampling, taking soil samples may be extremely difficult when the weather or field conditions are poor or when the crop is of sufficient age to inhibit traversing the field. This difficulty may result in failure to collect critical data.

### SUMMARY

In one example, a system is provided for sampling soil.

In one example, a method of sampling soil is provided.

In one example, a system is provided for determining soil sampling locations.

In one example, a method of determining soil sampling locations is provided.

In one example, a system is provided determining soil sampling locations and navigating or directing a user to the soil sampling locations.

In one example, a method of determining soil sampling locations and navigating or directing a user to the soil sampling locations is provided.

In one example, a system for grouping or clustering zones of a field, farm or land area of interest is provided based on one or more agronomic characteristics.

In one example, a method of grouping or clustering zones of a field, farm or land area of interest based on one or more agronomic characteristics is provided.

In one example, a system for grouping or clustering zones of a field, farm or land area of interest is provided based on agronomic similarities between the zones.

In one example, a method of grouping or clustering zones of a field, farm or land area of interest is provided based on agronomic similarities between the zones.

In one example, a method of sampling soil is provided and includes determining a soil sampling location, navigating to the soil sampling location with an electronic device, sampling soil at the soil sampling location, and displaying a visual image on the electronic device associated with a result obtained from the soil sample.

In one example, a manner for obtaining representative samples includes using a grid pattern, which assists with representing the entire field. In this form, a given field is divided up into various cells with each cell representing an area of the field. For example, when performing a grid pattern analysis, the soil sampler will select a parcel of land and then manually determine or, preferably, rely on a program to determine certain information such as grid size, shape, position and orientation. This information is then displayed to the operator via a device like a field computer, smartphone, other handheld device, smartwatch or other wearable item with displayable capabilities. Using this device, the operator can manually input the information required to calculate a grid based soil sampling plan manually (e.g., the desired X-axis grid length and Y-axis grid) or, in another embodiment, instruct the program to determine the grid based soil sampling plan based on the operator's current position and orientation. The operator may also be prompted to provide a geo-referenced starting point or collecting grid samples and an initial direction of travel.

This system may also utilize a directed sampling plan wherein calculation of soil sample collection locations may be based on some prior knowledge of the field. The information management system may generate a soil sampling plan based on spatial patterns defined by information such as the field management history, prior soil chemistry information, yield results, or the like instead of the spacial grid. Thus, the field may be divided into soil units of varying size which may be classified as being homogeneous. Each of these units may then be sampled independently in a manner similar to the grid sampling scheme described herein according to one example of the present disclosure.

In one example, a method of sampling soil is provided and includes determining a soil sampling location in a land area of interest by using, at least in part, an electronic device, displaying a first visual image associated with the soil sampling location on a display of the electronic device, navigating to the soil sampling location with the electronic device, sampling soil at the soil sampling location with a soil tester, and displaying a second visual image on the display of the electronic device associated with a result obtained from the soil sample.

In one example, the electronic device may be a mobile electronic communication device and the display may be a display of the mobile electronic communication device.

In one example, the method may further include indicating arrival at the soil sampling location with the electronic device.

In one example, indicating may further include providing, with the electronic device, at least one of an audible indication and a visual indication.

In one example, the method may further include relying on the result obtained from the soil sample to provide an agricultural prescription.

In one example, the agricultural prescription may be comprised of at least one agricultural action to be taken associated with at least one agricultural characteristic.

In one example, the agricultural prescription may be comprised of at least one of a soil sampling location, a type of soil sampling to be performed, a time to perform soil sampling and directions to a soil sampling location.

In one example, the agricultural prescription may be comprised of a soil sampling location, a type of soil sampling to be performed, a time to perform soil sampling and directions to a soil sampling location.

In one example, the method may further include communicating data associated with the soil sample from the soil tester to the electronic device.

In one example, communicating may further include communicating the data over at least one network to the electronic device.

In one example, determining a soil sampling location may further include determining a soil sampling location by using, at least in part, an electronic device based on historical data.

In one example, determining a soil sampling location may further include displaying a grid visual image on the display of the electronic device overlaid over a visual image of the land area of interest, wherein the grid visual image includes a plurality of cells with one of the cells representing the soil sampling location.

In one example, determining a soil sampling location may further include determining a plurality of soil sampling locations in the land area of interest by using, at least in part, the electronic device, wherein each of the plurality of cells represents one of the plurality of soil sampling locations.

In one example, the method may further include adjusting at least one of a size of the plurality of cells of the grid visual image and an orientation of the grid visual image relative to the visual image of the land area of interest with the electronic device.

In one example, the method may further include adjusting a size of the plurality of cells of the grid visual image with at least one first input device of the electronic device and adjusting an orientation of the grid visual image relative to the visual image of the land area of interest with at least one second input device of the electronic device.

In one example, the method may further include indicating arrival at the soil sampling location with the electronic device when the electronic device is geographically located within the one of the cells representing the soil sampling location.

In one example, determining a soil sampling location may further include determining a plurality of soil sampling locations in the land area of interest by using, at least in part, the electronic device, and navigating may further include navigating to the one of the plurality of soil sampling locations that is geographically closest to the electronic device.

In one example, navigating may further include displaying at least one of a visual image of a direction toward the soil sampling location and a visual image of a distance to the soil sampling location on the display of the electronic device.

In one example, the method may further include displaying both the visual image of the direction and the visual image of the distance on the display of the electronic device.

In one example, the method may further include inputting data associated with an observation made in the land area of interest into the electronic device, and the observation may be associated with at least one of a weed, a pest, a rock and a disease.

### BRIEF DESCRIPTION OF THE DRAWINGS

The disclosure can be better understood with reference to the following drawings and description. The components in the figures are not necessarily to scale, emphasis instead being placed upon illustrating principles of the disclosure.

FIG. 1 is a schematic block diagram of one example of a system of the present disclosure, the system is configured to perform at least a portion of the functionality and methods of the present disclosure.

FIG. 2 is a schematic block diagram of one example of a soil tester of the system shown in FIG. 1.

FIG. 3 is a perspective view of one example of a soil probe included in the soil tester shown in FIG. 2.

FIG. 4 is a perspective view of one example of a soil analyzing device included in the soil tester shown in FIG. 2.

FIG. 5 is one example of a visual image displayed by the system on a display of an electronic device, such as a mobile electronic communication device, associated with prompting a user to input information pertaining to a field, farm or land area of interest.

FIG. 6 is one example of a visual image displayed by the system on a display of an electronic device, such as a mobile electronic communication device, associated with prompting a user to input information pertaining to a name of the field, farm or land area of interest.

FIG. 7 is one example of a visual image displayed by the system on a display of an electronic device, such as a mobile electronic communication device, associated with prompting a user to input information pertaining to a mission or type of analysis to be performed with respect to the field, farm or land area of interest.

FIG. 8 is one example of a visual image displayed by the system on a display of an electronic device, such as a mobile electronic communication device, associated with prompting a user to input information pertaining to the field, farm or land area of interest or providing a user an ability to select or activate an icon or hyperlink that results in the system obtaining, receiving and/or retrieving data associated with a field, farm or land area of interest.

FIG. 9 is one example of a visual image displayed by the system on a display of an electronic device, such as a mobile electronic communication device, associated with a field, farm or land area of interest.

FIG. 10 is one example of a visual image displayed by the system on a display of an electronic device, such as a mobile electronic communication device, associated with a field, farm or land area of interest.

FIG. 11 is one example of a visual image displayed by the system on a display of an electronic device, such as a mobile electronic communication device, associated with prompting a user to input information pertaining to the field, farm or land area of interest.

FIG. 12 is one example of a visual image displayed by the system on a display of an electronic device, such as a mobile electronic communication device, associated with prompting a user to input information pertaining to the field, farm or land area of interest.

FIG. 13 is one example of a visual image displayed by the system on a display of an electronic device, such as a mobile electronic communication device, associated with prompting a user to input information pertaining to the field, farm or land area of interest.

FIG. 14 is one example of a visual image displayed by the system on a display of an electronic device, such as a mobile electronic communication device, associated with the field, farm or land area of interest, where the visual image includes a grid laid over the farm, field or land area of interest.

FIG. 15 is one example of a visual image displayed by the system on a display of an electronic device, such as a mobile electronic communication device, associated with the field, farm or land area of interest, where the visual image includes a grid laid over the farm, field or land area of interest.

FIG. 16 is one example of a visual image displayed by the system on a display of an electronic device, such as a mobile electronic communication device, associated with prompting a user to input information pertaining to the field, farm or land area of interest.

FIG. 17 is one example of a visual image displayed by the system on a display of an electronic device, such as a mobile electronic communication device, associated with the field, farm or land area of interest, where the visual image includes a grid laid over the farm, field or land area of interest.

FIG. 18 is one example of a visual image displayed by the system on a display of an electronic device, such as a mobile electronic communication device, associated with the field, farm or land area of interest.

FIG. 19 is one example of a visual image displayed by the system on a display of an electronic device, such as a mobile electronic communication device, associated with the field, farm or land area of interest.

FIG. 20 is one example of a visual image displayed by the system on a display of an electronic device, such as a mobile electronic communication device, associated with prompting a user to input information pertaining to the field, farm or land area of interest, where the information pertains to a soil sample.

FIG. 21 is one example of a visual image displayed by the system on a display of an electronic device, such as a mobile electronic communication device, associated with the field, farm or land area of interest.

FIG. 22 is one example of a visual image displayed by the system on a display of an electronic device, such as a mobile electronic communication device, associated with prompting a user to input information pertaining to the field, farm or land area of interest, where the information pertains to a soil sample.

FIG. 23 is one example of a visual image displayed by the system on a display of an electronic device, such as a mobile electronic communication device, associated with displaying soil sampling results associated with a soil sample conducted in connection with the field, farm or land area of interest.

FIG. 24 is one example of a visual image displayed by the system on a display of an electronic device, such as a mobile electronic communication device, associated with prompting a user to input information pertaining to the field, farm or land area of interest, where the information pertains to an observation.

FIG. 25 is one example of a visual image displayed by the system on a display of an electronic device, such as a mobile electronic communication device, associated with a list of examples of observation categories.

FIG. 26 is one example of a visual image displayed by the system on a display of an electronic device, such as a mobile electronic communication device, associated with observations made in connection with the field, farm or land area of interest.

FIG. 27 is one example of a visual image displayed by the system on a display of an electronic device, such as a mobile electronic communication device, associated with the observations made in connection with the field, farm or land area of interest.

FIG. 28 is one example of a manner of visually representing a plurality of zones or portions of a field, farm or land area of interest and the system grouping or clustering the plurality of zones into groups, in this example the system groups the zones into three groups.

FIG. 29 is another example of a manner of visually representing a plurality of zones or portions of a field, farm or land area of interest and the system grouping or clustering the plurality of zones into groups, in this example the system groups the zones into five groups.

FIG. 30 is one example of a manner of visually representing and/or outputting information or data associated with grouping or clustering zones or portions of a field, farm or land area of interest, in this example the system outputs the information or data in a color-coded map with the various groups having different colors associated therewith.

### DETAILED DESCRIPTION

The present disclosure provides systems, methods and apparatuses associated with soil sampling. The systems, methods and apparatuses provide one or more of considering fields and/or land areas of interest to determine appropriate or ideal soil sampling locations for particular fields and/or land areas of interest, determining soil sampling locations for one or more fields and/or land areas of interest, navigating individuals to soil sampling locations, taking one or more soil samples at the soil sampling locations, uploading soil samples to at least one of a mobile electronic communication device and/or a server and/or storage device, displaying soil samples on a mobile electronic communication device, and/or a variety of other steps, functionalities and/or operations.

The systems, methods and apparatuses of the present disclosure allow a user to interact with the system to input information and/or data, then the systems, methods and apparatuses consider and/or analyze the inputted information and/or data to perform one or more of the steps, functionalities and/or operations described herein. The systems, methods and apparatuses are also capable of outputting and/or transmitting results subsequent to considering and/or analyzing for subsequent consideration and/or analyzing.

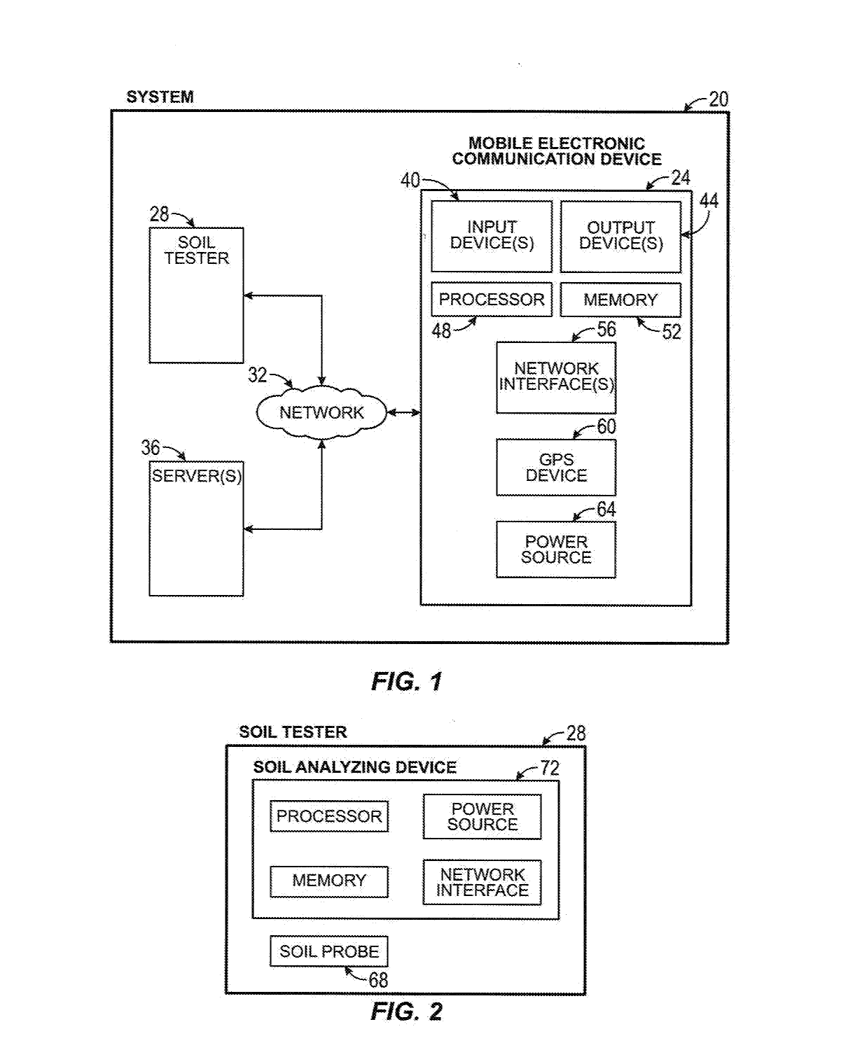

With reference to FIG. 1, one example of a system 20 of the present disclosure is illustrated and is capable of performing the steps, functionalities and/or operations of the present disclosure. This exemplary system is only one example of many possible systems of the present disclosure, is not intended to limit the present disclosure and is provided to demonstrate at least some of the principles of the present disclosure. All of such possible systems are intended to be within the spirit and scope of the present disclosure.

With continued reference to FIG. 1, the system includes a mobile electronic communication device 24, a soil tester 28, a network 32 and a server or other storage and/or processing device 36. The system is capable of including more or less components and all of such possibilities are intended to be included in the spirit and scope of the present disclosure. The exemplary components illustrated in FIG. 1 and described hereinafter are provided to demonstrate at least a portion of the principles of the present disclosure and should not be considered as limiting. The system is capable of including any component necessary to perform the steps, functionalities and/or operations of the present disclosure and such components may be conventional in the art.

In the illustrated example, only one network is illustrated; however, the system is capable of including multiple networks. The network may be a wide variety of types of networks and the present disclosure contemplates using any type of network. For example, the network 32 may be one or more of an Internet, an intranet, a cellular network, a local area network (LAN), a wide area network (WAN), a cable network, or any other type of network that is capable of transmitting information, such as digital data, and the like. In examples where the system includes multiple networks, the multiple networks may be similar types of networks or the networks may be different types of networks. For example, the system may communicate over a cellular network and over the Internet.

The system is configured to communicate data to a wide variety of devices over one or more networks and any such devices are intended to be within the spirit and scope of the present disclosure. In the illustrated example, the system is configured to communicate over one or more networks with personal computer(s), mobile electronic communication device(s) (illustrated in FIG. 1 for exemplary purposes), and/or agricultural device(s). The mobile electronic communication devices may be a wide variety of devices including, but not limited to, a personal desktop assistant (PDA), a portable computer, a mobile telephone, a smartphone, a netbook, a mobile vehicular computer, a tablet computer, a smartwatch or watch with a display, a wearable item including a display or having displayable capabilities, or any other type of mobile electronic communication device. The agricultural devices may be a wide variety of agricultural devices including, but not limited to, tractors, planters, harvesters, sprayers, any input application device, irrigation devices, soil sampling devices, agronomic sensors, agronomic devices for sampling agronomic characteristics, etc. The system is also configured to communicate over one or more networks with a single device at a time or multiple devices contemporaneously, intermittently or interchangeably. For example, the system may communicate with a user's smartphone over a cellular network. Also, for example, the system may communicate with a tractor over a cellular network. Further, for example, the system may communicate with a user's personal computer over the Internet and communicate with the user's smartphone over a cellular network.

In the illustrated example, the system is shown with a mobile electronic communication device; however, as described above, the system may also include other electronic devices and agricultural devices. In the illustrated example, the mobile electronic communication device includes one or more input devices 40, one or more output devices 44, a processor 48, memory 52, one or more network interfaces 56 (for interfacing with one or more networks), a GPS device 60 and a power source 64. The components illustrated in FIG. 1 in connection with the mobile electronic communication device are merely exemplary of the many possible components that may be included in the mobile electronic communication device and are illustrated to demonstrate at least some of the principles of the present disclosure. It should be understood that the mobile electronic communication device may include more, less or different components and all of such possibilities are intended to be within the spirit and scope of the present disclosure. The mobile electronic device is capable of including any component necessary to perform the functionality and operations of the mobile electronic device associated with the present disclosure.

The exemplary system illustrated in FIG. 1 also includes one or more servers. Servers and their components and functionality are conventional in the art and, therefore, are not described in significant detail herein.

With reference to FIG. 2, one example of a soil tester of the system is illustrated. The illustrated soil tester is provided to demonstrate at least some of the principles of the present disclosure and is not intended to be limiting. While only one example of a soil tester is illustrated and described, the system is capable of including a wide variety of soil testers and all of such possibilities are intended to be within the spirit and scope of the present disclosure. In one example, the soil tester is capable of collecting or taking a soil sample and testing or analyzing the soil sample to provide soil test results. In one example, the soil tester is capable of collecting or taking a soil sample. In another example, the soil tester is capable of testing or analyzing a soil sample to provide soil test results.

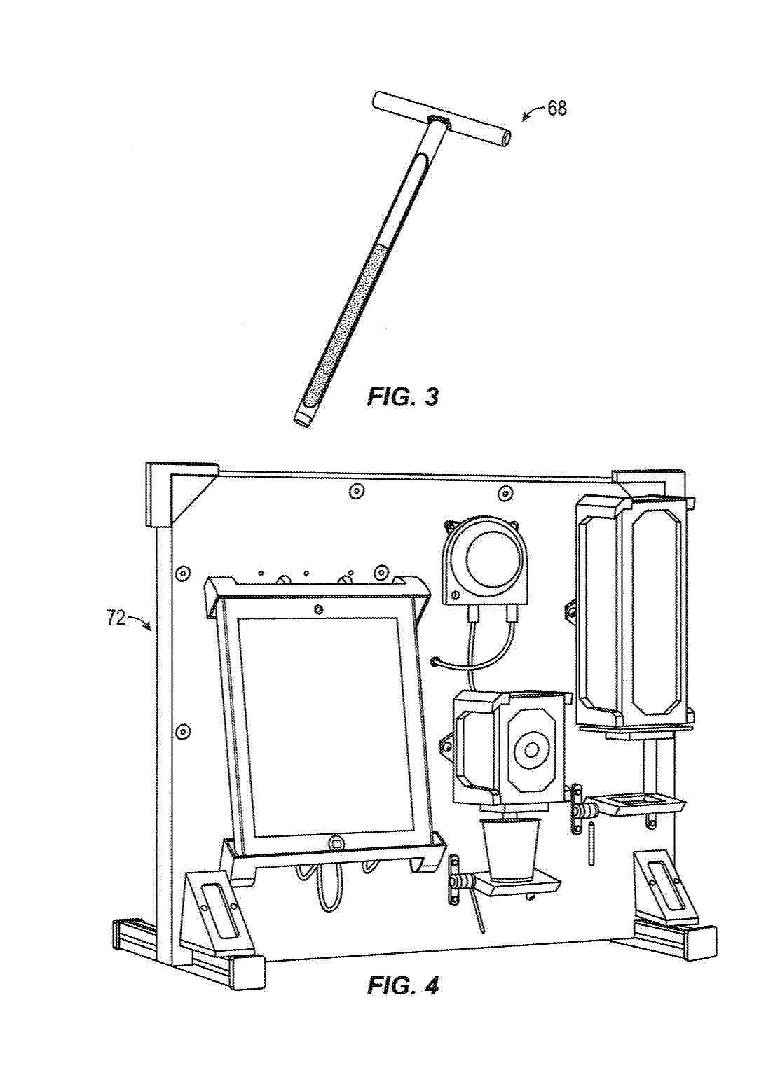

In the example illustrated in FIG. 2, the soil tester is capable of both collecting or taking a soil sample and testing or analyzing the soil sample to provide soil test results. In the illustrated example, the soil tester includes a soil probe 68 for collecting or taking a soil sample. One example of a soil probe is illustrated in FIG. 3. This exemplary soil probe is one of many types of soil probes that may be part of the soil tester and is not intended to limit the present disclosure. The exemplary soil probe is provided to demonstrate at least some of the principles of the present disclosure. In the illustrated example, the soil tester also includes a soil analyzing device 72 for testing or analyzing the soil sample to provide soil test results. One example of a soil analyzing device is illustrated in FIG. 4. This exemplary soil analyzing device is one of many types of soil analyzing devices that may be part of the soil tester and is not intended to limit the present disclosure. The exemplary soil probe is provided to demonstrate at least some of the principles of the present disclosure. The illustrated exemplary soil analyzing device is described in detail in U.S. patent application Ser. No. 14/253,926, filed Apr. 16, 2014, and 62/168,649, filed May 29, 2015, the contents of all of which are incorporated by reference herein.

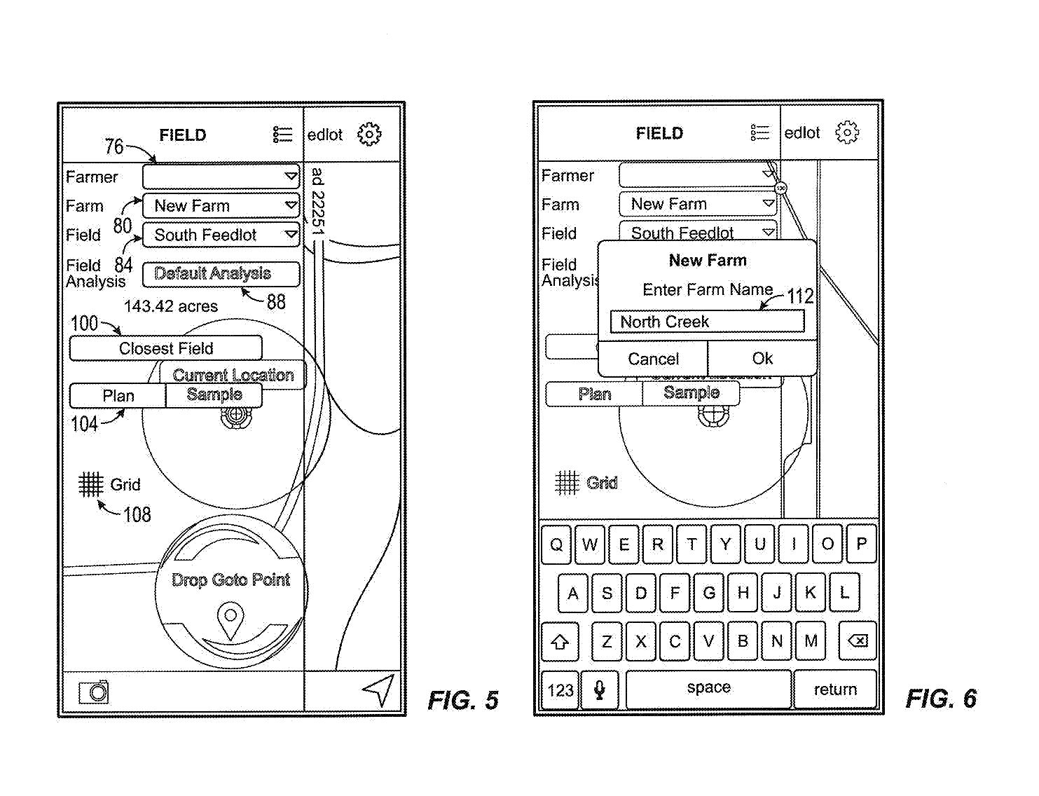

Referring now to FIGS. 5-27, examples of visual images associated with various steps, functionalities and/or operations of the system displayed or otherwise outputted on a display or other output device of an electronic device such as, for example, an electronic mobile communication device (e.g., smartphone, tablet, cellular or Wi-Fi enabled device, etc.) by the system are illustrated. These visual images are examples of visual images that may be outputted and are not intended to limit the present disclosure. It should be understood that the system is capable of displaying or outputting any of a wide variety of visual images, in any configuration or visual format, and all of such possibilities are intended to be within the spirit and scope of the present disclosure.

In one example, one or more visual images may be displayed on a mobile electronic communication device to prompt a user to input information pertaining to the field, farm or land area of interest. FIG. 5 illustrates one example of a visual image displayed on a mobile electronic communication device containing examples of some of the information and/or data prompted to a user. Such information may include, but is not limited to, name of a farmer 76, name of a farm 80, name of a field on the farm 84 (i.e., some farms may include more than one field or may desire to separate a field or land area of interest into a plurality of zones or areas), select a type of field analysis 88, mission or goal 92 to be achieved by the system with the respective field, farm or land area of interest, select a field or land area of interest 100 geographically closest to a present location of the user and/or mobile electronic communication device, select between establishing a soil sampling plan or a land area of interest or sampling a land area of interest 104, setting a grid for a land area of interest 108, among other information and capabilities.

With reference to FIG. 6, one example of a visual image prompting a user to input information and/or data is illustrated. In this example, the visual image is associated with a name of the farm 80 and is prompting a user to input a name for the farm or land area of interest 112. Similar visual images may be displayed or outputted on the mobile electronic communication device to prompt a user to input other information and/or data associated with the land area of interest. The system organizes and stores the information and/or data input by the user.

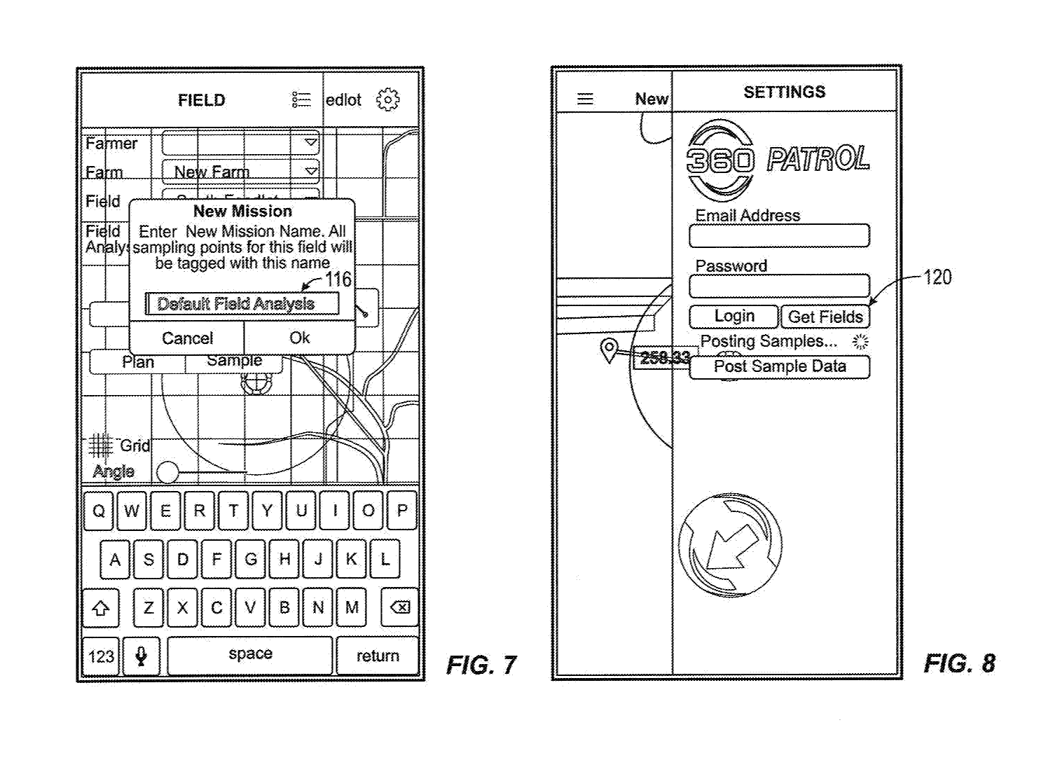

Referring now to FIG. 7, one example of a visual image prompting a user to input a type of analysis to be performed or achieved by the system for the associated land area of interest 116 is illustrated. This visual image is displayed on the mobile electronic communication device when a user selects the data box associated with the field analysis 88 (see FIG. 5). The system may be used to achieve or perform a wide variety of missions, analysis, goals, activities, etc. For example, the system may perform soil sampling, crop scouting, soil nutrient analysis, plant emergence analysis, crop yield check, vegetative state analysis, observations, among many others. With respect to crop yield check, in one example, a user may check a yield of a crop at various growth stages of the crop. In one example, a user may check an ear of corn by counting a quantity of rows of kernels and counting a quantity of kernels in each row. Then these observed quantities of rows and kernels may be input into the system and the system may compare such inputted data to typical, desired or expected quantities of rows and kernels at the growth stage associated with the time of the observation.

Once a user inputs identification information and/or data, the user may select or associate a particular field, farm or land area of interest with the identification information. The system is capable of obtaining or receiving information and/or data associated with a field, farm and/or land area of interest in a variety of manners and from a variety of sources.

In one example, the system may load field information for a field closest to the user and/or mobile electronic communication device. In such an example, the user may select or activate the closest field icon or hyperlink 100 displayed on the display of the mobile electronic communication device (see FIG. 5). The system would then obtain, receive and/or retrieve data from a third party database, server or other device with data storage capabilities associated with the field closest to the user and/or mobile electronic communication device. The closest field could be identified with assistance from a global positioning system (GPS) 60 included in the mobile electronic communication device 24.

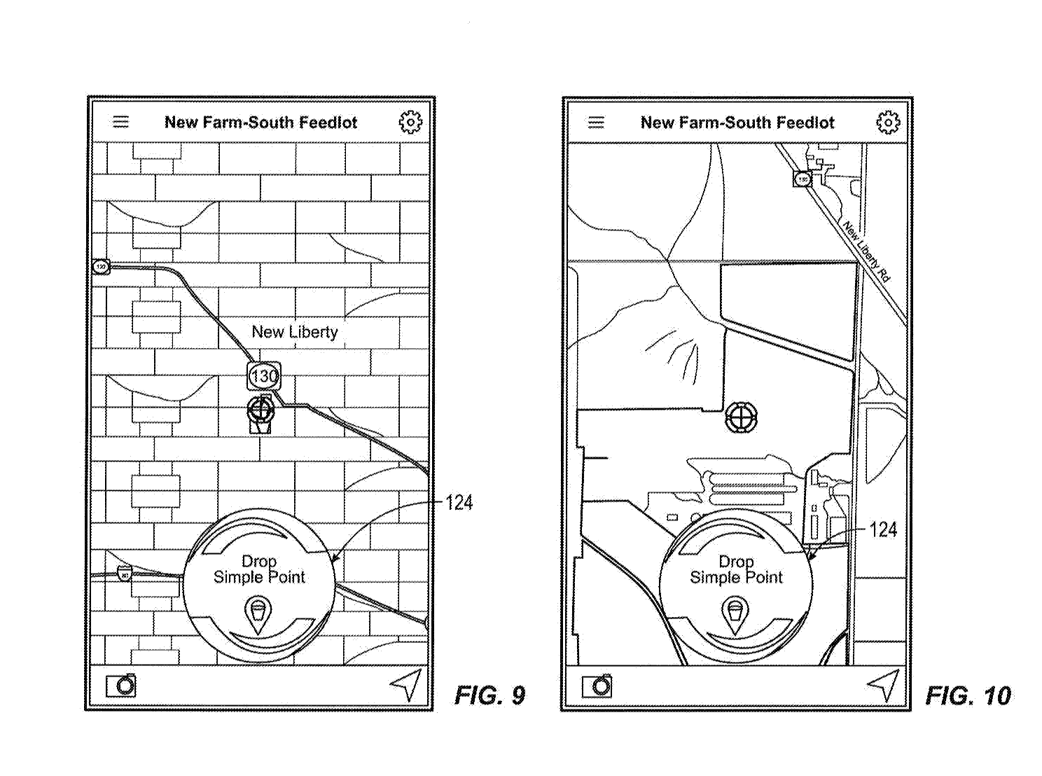

In one example, the system may obtain, receive and/or retrieve data associated with the field, farm or land area of interest from a third party database, server or other device with storage capabilities. A user may instruct or direct the system to obtain, receive and/or retrieve data associated with a particular field, farm or land area of interest. For example, with reference to FIG. 8, a user may select or activate a “Get Fields” icon or hyperlink 120 that results in the system obtaining, receiving and/or retrieving data associated with a field, farm or land area of interest.

In one example, the system may display a map including a field, farm or land area of interest and a user may be able to draw or otherwise select boundaries of the field, farm or land area of interest with the system to define the field, farm or land area of interest. The system may select the map displayed thereon or a user may navigate geographically to a desired field, farm or land area of interest. Once the desired geographic location is displayed on the display, a user may draw or otherwise select the boundaries of the field, farm or land area of interest.

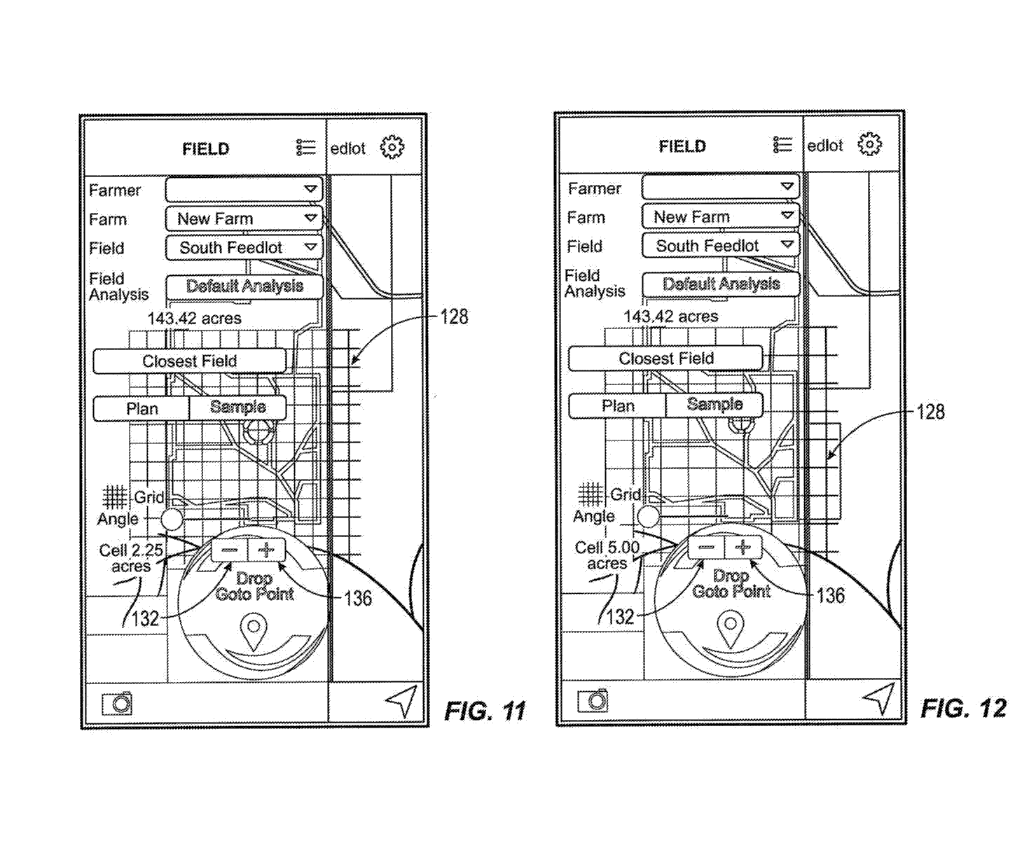

Once the desired field, farm or land area of interest is selected, locations for performing soil samples may be determined when the type of analysis for this particular field, farm or land area of interest is soil sampling. With reference to FIGS. 9 and 10, the same farm is illustrated at various degrees of magnification. In one example, the system displays an indicator such as, for example, a cross-hairs, that may be moved by a user via one or more input device(s) on the mobile electronic communication device. The indicator indicates a point where a sampling point may be dropped or marked by activating or actuating a button, icon or actuator 124 via one or more input device(s) on the mobile electronic communication device. In the illustrated example, the button 124 is entitled “Drop Sampling Point”. The user moves the indicator to a desired location on the farm and activates or actuates the button to drop or mark a sampling location on the farm. The user may drop or mark as many sampling locations on the farm as desired.

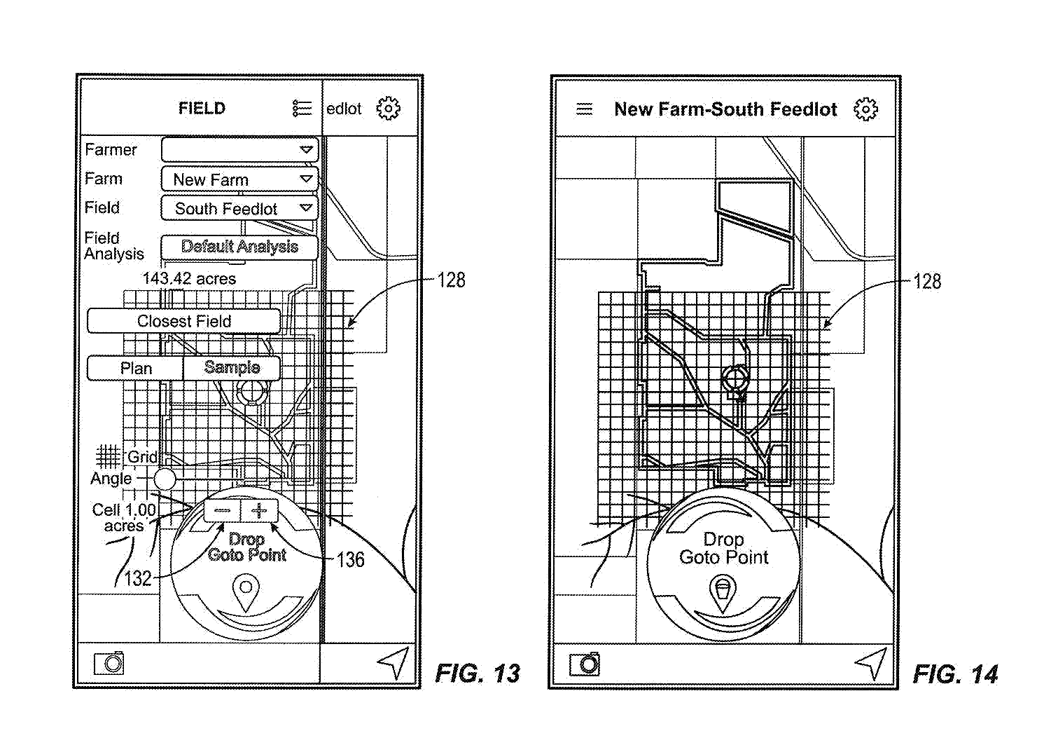

In one example, the system provides an ability to overlay a grid 128 onto the field, farm or land area of interest displayed on the display of the mobile electronic communication device 24. The grid may assist with determining soil sampling locations that represent a complete profile of the field, farm or land area of interest. With reference to FIG. 11, one example of a visual image displayed by the system on a mobile electronic communication device is illustrated and provides a user with the ability to overlay a grid on a field, farm or land area of interest. The system also provides the user with the ability to adjust characteristics associated with the grid via one or more input device(s) on the mobile electronic communication device. In one example, a size of the cells of the grid may be adjusted by a user by increasing or decreasing the size of the cells via one or more input device(s) such as one or more touch screen actuators 132, 136 displayed on the display of the mobile electronic communication device (e.g., actuators identified by a plus sign and a minus sign to respectively increase and decrease a size of the cells of the grid). For example, in FIG. 11, the size of the grid cells is 2.25 acres per cell. Alternatively, for example, in FIG. 12, the size of the grid cells has been increased to 5.00 acres per cell. Further, for example, in FIG. 13, the size of the grid cells has been decreased to 1.00 acres per cell. It should be understood that the size of the grid cells may be adjusted to any size and at any increment between cell sizes, and all of such possibilities are intended to be within the spirit and scope of the present disclosure.

With reference to FIG. 14, one example of a grid is illustrated overlaid on a field, farm or land area of interest on a display of the mobile electronic communication device. In this illustrated example, the cell size is 1.00 acres and is associated with FIG. 13. Once the system overlays the grid on the field, farm or land area of interest, soil sampling locations may be set or established via one or more input device(s) on the mobile electronic communication device.

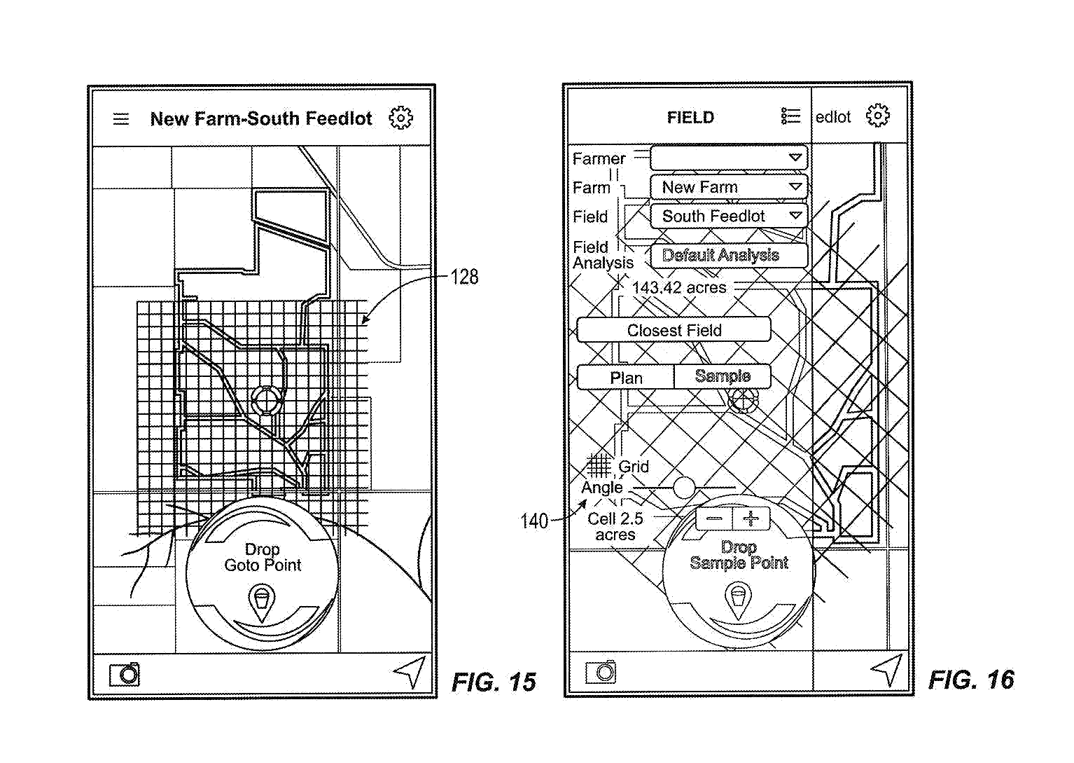

With reference to FIG. 14 and further reference to FIG. 15, the indicator 130 may be moved to a desired soil sampling location and the actuator 124 (e.g., in this example, the actuator is identified by “Drop Goto Point”) may be actuated to set or establish a soil sampling point at the location of the indicator 130 via one or more input device(s) on the mobile electronic communication device. This process of moving the indicator and setting soil sampling points may be repeated as desired. In one example, a user may set one soil sampling point for each cell via one or more input device(s) on the mobile electronic communication device. In another example, a user may set any number of soil sampling points for each cell. In a further example, a user may decide to set one or more sampling points in some of the cells and may decide to not set any soil sampling points in other cells.

With reference to FIG. 16, the configuration of the grid may be altered in another manner. For example, the grid may be angled relative to the field, farm or land area of interest via one or more input device(s) on the mobile electronic communication device. Angling of the grid may position the grid in a more desirable or favorable orientation relative to the field, farm or land area of interest. Fields, farms and land areas of interest come in a wide variety of shapes, sizes and configurations, and providing a user with a variety of manners to modify the configuration of the grid system ensures the grid may be favorably positioned, oriented, sized, etc., relative to the field, farm or land area of interest to result in adequate placement of soil sampling locations. In one example, the system displays an actuator 140 (e.g., a touchscreen input device displayed on the display of the mobile electronic communication device) that may be actuated by a user to change an angle of the grid relative to the field, farm or land area of interest. In the illustrated example, the actuator is a slide bar. It should be understood that the actuator may be any type of actuator/input device that is capable of changing an angle of the grid relative to the land area of interest and all of such possibilities are intended to be within the spirit and scope of the present disclosure. It should also be understood that the angle of the grid may be altered between any range of angles and in any increments within the range of angles, and all of such possibilities are intended to be within the spirit and scope of the present disclosure. Referring to FIG. 17, one example of the system overlaying/displaying an angled grid on a field, farm or land area of interest on the display of the mobile electronic communication device is illustrated.

In one example, once the system overlays/displays a grid on a field, farm or land area of interest and the desired soil sampling locations are set or established, the process of determining soil sampling locations or the planning process may be complete. With a completed planning process for a field, farm or land area of interest, the system may utilize the soil sampling plan to actually perform soil sampling.

A user may utilize the system to navigate to the soil sampling locations established by the system in connection with a particular field, farm or land area of interest. A user may travel to the field, farm or land area of interest with a mobile electronic communication device capable of displaying visual images associated with the system. Upon being located at the field, farm or land area of interest, the system will utilize the GPS device on the mobile electronic device to determine a location of the mobile electronic communication device and the user (who is holding the mobile electronic communication device).

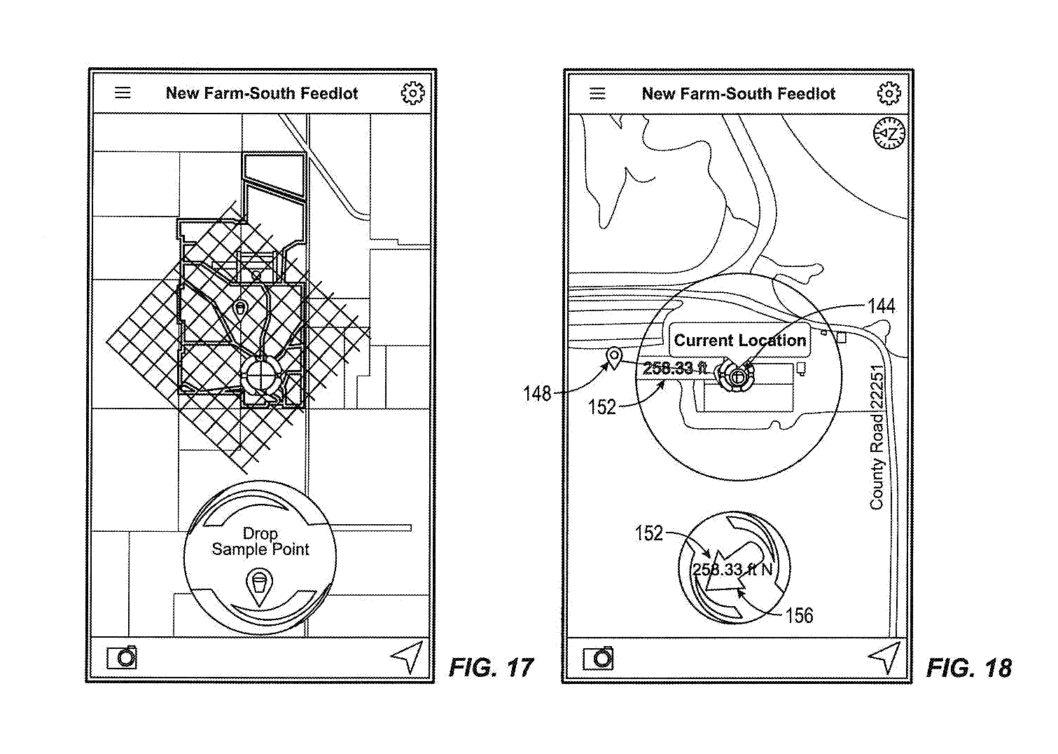

In one example, the system will select the nearest soil sampling location and display information or data on the display of the mobile electronic communication device to direct the user to the nearest soil sampling point. In one example, with reference to FIG. 18, the system displays: A current location of the mobile electronic communication device and user holding the mobile electronic communication device 144, the soil sampling location 148, a distance to the soil sampling location 152, and a direction to the soil sampling location 156. This information is extremely helpful to a user in the field, farm or land area of interest to ensure the user makes it to the correct location and takes a soil sample at the correct location. In the past, users would guess or approximate desired soil sampling locations and, without any directions or guidance to the accurate soil sampling location, the user often ended up in an incorrect location and taking a soil sample at the incorrect location. Once a user reaches the soil sampling location, the system provides a notification to notify the user that he/she has reached the soil sampling location. In one example, the notification may be visibly displayed on a display of the mobile electronic communication device. In one example, the notification may be an audible sound emitted by a speaker or other audio producing device of the mobile electronic communication device. In one example, the notification may be both visibly displayed on and audibly emitted by the mobile electronic communication device.

In one example, a user may select, via one or more input devices of the mobile electronic communication device, any one of the desired soil sampling locations and the system will display information or data on the display of the mobile electronic communication device to direct the user to the selected soil sampling location. In this example, the system may display similar information or data to that illustrated in connection with FIG. 18 and the previous paragraph to direct a user to the selected soil sampling location.

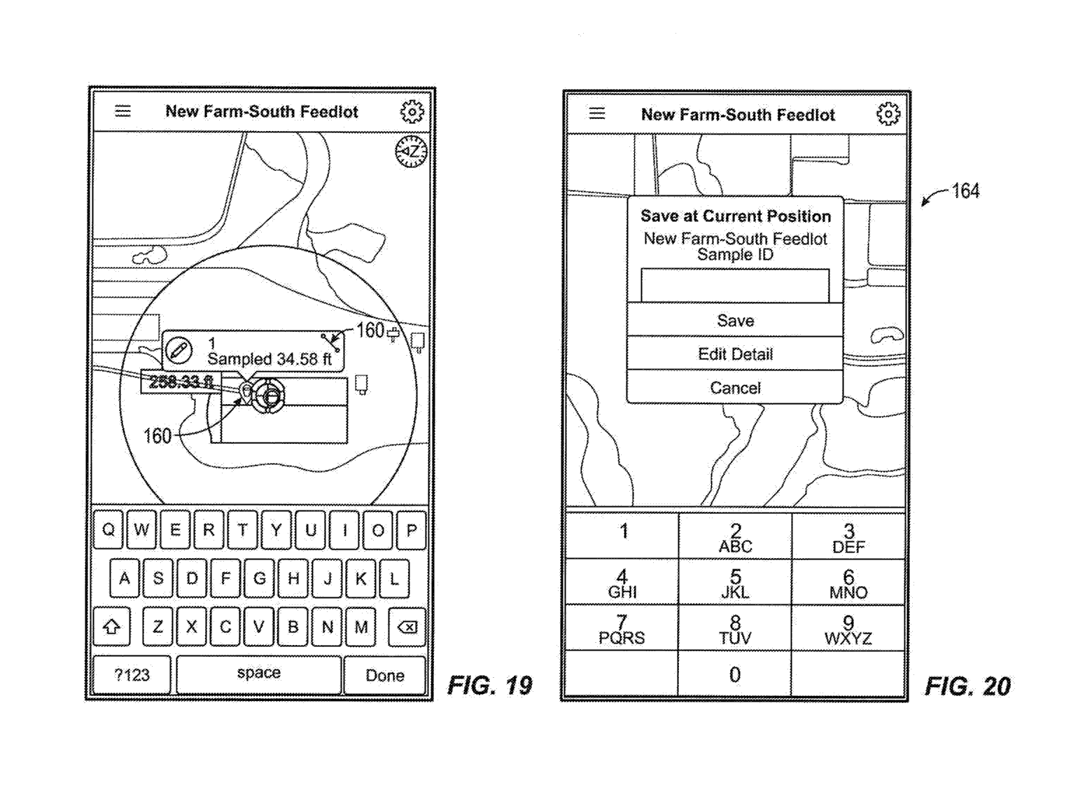

In one example, with reference to FIG. 19, the system may create a heading between two established locations by pairing the two locations. In this example, a user may select an actuator 160, such as, for example, the line segment with two points at its ends, to pair two points (the line segment may be displayed on a touchscreen display of a mobile electronic communication device and the line segment may be activated due to the touchscreen capabilities—the touchscreen is an input device of the mobile electronic communication device). Upon selection or activation of the actuator/input device, the system determines a path between the two locations and displays similar information or data to that described above with respect to FIG. 18 to assist with navigating a user to the desired location.

Upon a user arriving at a desired soil sampling location, a user may use a soil tester 28 to test the soil at the soil sampling location. The user may use a wide variety of soil testers to test the soil. The exemplary soil tester described and illustrated herein is not intended to limit the present disclosure. Rather, the described and illustrated example of the soil tester is merely one example of many types of examples of soil testers capable of being part of the system and all of such possibilities are intended to be within the spirit and scope of the present disclosure.

When the user is ready to perform a soil sample, the user may use one or more input device(s) on the mobile electronic communication device to enter identifying information or data associated with the soil sample to be performed. One example of a visual image 164 displayed by the system on the mobile electronic communication device to facilitate information or data entry by the user associated with the soil sample is illustrated in FIG. 20.

Referring now to FIG. 21, when the user takes the soil sample, the user activates or selects an actuator 168 displayed on the display of the mobile electronic communication device (e.g., one or more input device(s)) to establish the location in the field, farm or land area of interest where the sample was taken. In the illustrated example, the actuator 168 is identified by “Record Sample”. In one example, the system may display an indicator 172 on the display of the mobile electronic communication device at the location where the user activates the actuator 168. This indicator 172 identifies where the soil sample was taken. In one example, the indicator 172 is an image of a soil filled bucket (see FIG. 19).

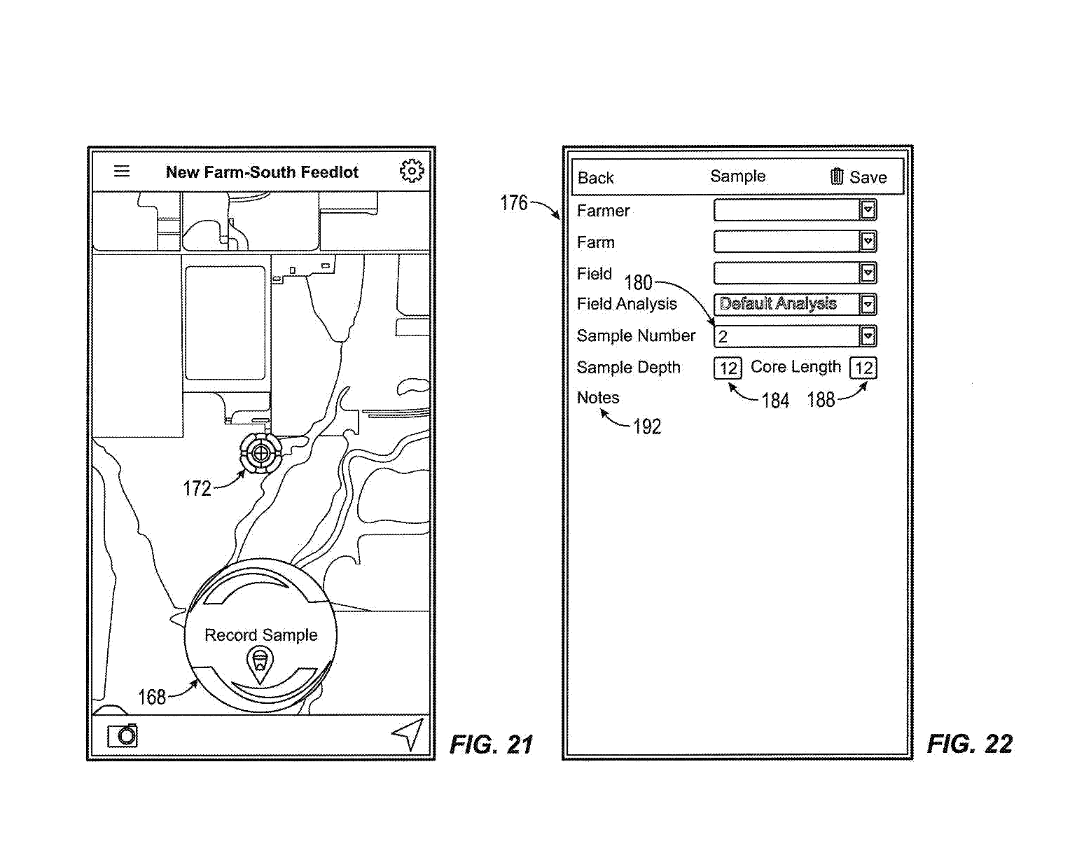

In one example, with reference to FIG. 22, upon activation of the actuator, the system displays a plurality of data fillable fields 176 on the display of the mobile electronic communication device. The data fillable fields on the display may pertain to various characteristics associated with the soil sample performed by the user with the soil tester. The plurality of data fillable fields may pertain to any characteristics associated with soil sample and all of such possibilities are intended to be within the spirit and scope of the present disclosure. In the illustrated example, the data fillable fields include a number 180 that may be associated with the soil sample (e.g., is the soil sample the first soil sample, second soil sample, third soil sample, etc.), a depth of the sample 184 (e.g., the depth of the soil sample may be associated with a number and any desired unit of measure—in the illustrated example, the unit of measure is inches), a core length of the sample 188 (e.g., the core length of the soil sample may be associated with a number and any desired unit of measure—in the illustrated example, the unit of measure is inches), and a notes section 192 where a user may input any desired notes associated with the soil sample. In the illustrated example, the other data fields may have been previously populated with information/data as described earlier.

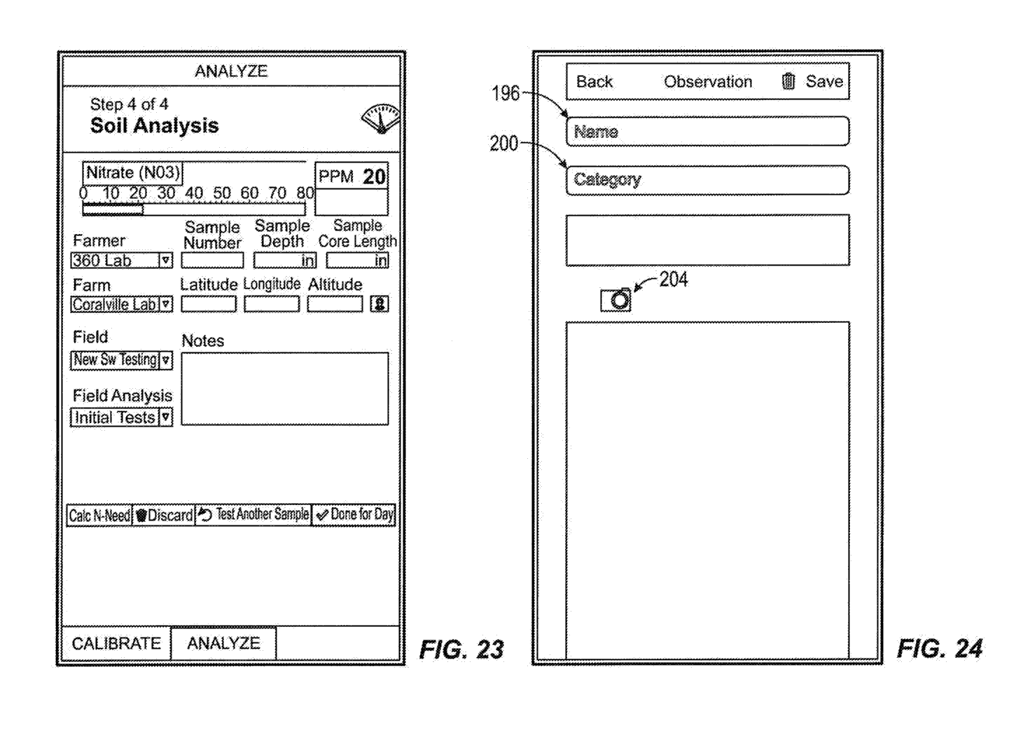

The soil tester is capable of testing a wide variety of soil characteristics and is capable of displaying the soil sample results in a wide variety of manners. With reference to FIG. 23, one example of a visual image displayed on the display of the mobile electronic communication device is illustrated including soil test results. This example is only one of many possible manners of displaying soil testing results and all of such possibilities are intended to be within the spirit and scope of the present disclosure. In one example, the soil tester is configured to transmit or communicate information and/or data associated with the test results to one or more server(s) via one or more network(s) where the mobile electronic communication device may retrieve information and/or data from the one or more server(s) associated with the test results via the one or more network(s). Once the mobile electronic communication device receives/retrieves the data, the mobile electronic communication device may display the soil test results associated with the received/retrieved information and/or data. In another example, the visual image of FIG. 23 may be displayed on a display of the soil tester. To this point, it should be understood that any of the visual images, information and/or data, soil test results, etc., may be displayed on any of the components of the system and such components are capable of including a display to display such images. For example, any of the visual images displayed on the mobile electronic communication device may be displayed on the soil tester or an agricultural device or any other electronic device associated with the system that includes a display.

Subsequent to sampling the soil at a first soil sampling location, the system may navigate the user to other soil sampling locations where the user may perform additional soil sampling tests. This continues until the user has tested the soil at the desired amount of soil testing locations.

While a user navigates the field, farm or land area of interest, the user may make observations that are worth documenting or preserving for future consideration. The system provides the user with the ability to make these observations and document, record, save or otherwise preserve information and/or data associated with the observations. Several activities, events, occurrences, etc., may occur in afield, farm or land area of interest that may justify an observation by the user including, but not limited to, the presence of weeds, pests, disease, rocks, other, etc.

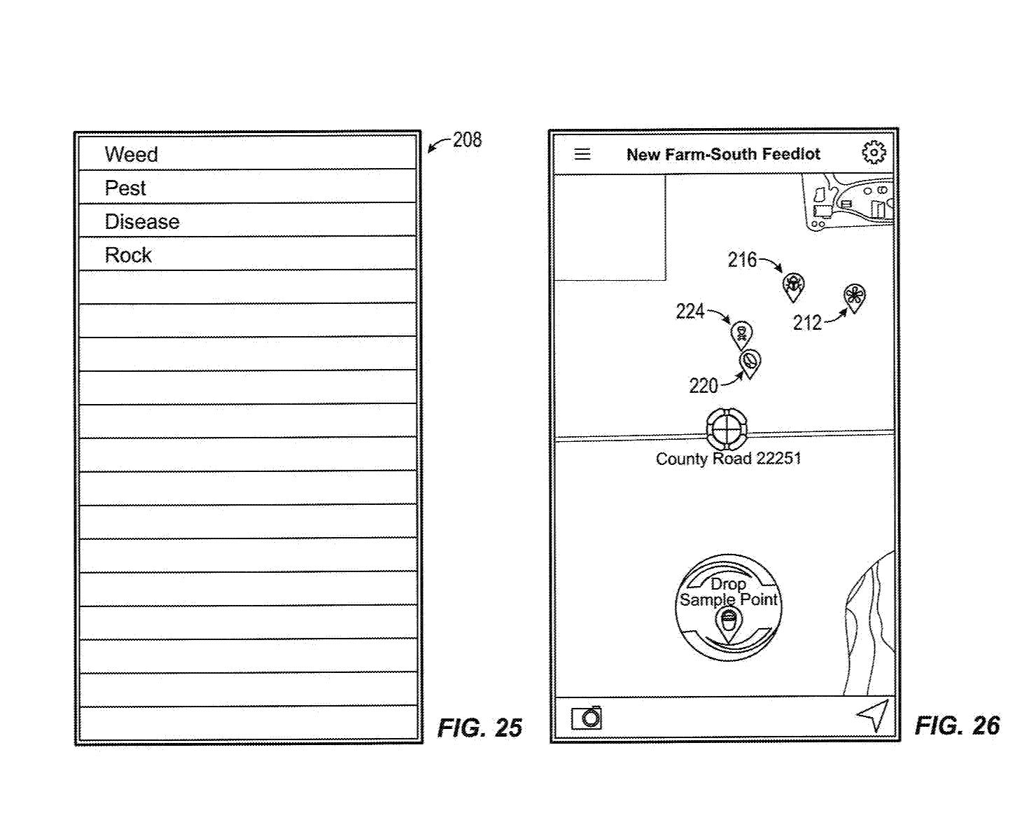

With reference to FIG. 24, a user may actuate an actuator/input device displayed on a display of the mobile electronic communication device indicating that an observation is desired. In one example, the system responds by displaying a visual image, such as, for example, the image illustrated in FIG. 24 on the mobile electronic communication device for viewing by the user. In this example, the system allows a user to provide a name for the observation by displaying a “Name” field 196 where a user may input, via one or more input device(s), information or data associated with a name of the observation, allows a user to select, via one or more input device(s), from a plurality of predetermined categories or to input, via one or more input device(s), their own category if such a category is not in the predetermined list at a displayed “Category” field 200, and allows a user to capture a visual image (e.g., take a picture) associated with the observation by actuating the camera actuator 204 (e.g., a touchscreen input device) displayed on the mobile electronic communication device. When a user actuates or otherwise selects the “Category” field 200, the system may display a visual image including a predetermined list of categories 208 from which to select. In one example, such a visual image with the predetermined list may have an appearance similar to that illustrated in FIG. 25. This list of predetermined observation categories 208 is not intended to be limiting. Rather, the predetermined list of observation categories may have any type and any quantity of observations, and all of such possibilities are intended to be within the spirit and scope of the present disclosure.

The system is also capable of displaying an image on the map of the field, farm or land area of interest associated with the observation displayed on the display of the mobile electronic communication device. The system relies on the GPS device of the mobile electronic communication device to determine the location of the mobile electronic communication device when the observation is made, associates the location of the mobile electronic communication device with the field, farm or land area of interest, and displays an image associated with the observation on the displayed image of the field, farm or land area of interest where the observation was made. The various observation categories may each have their own images. For example, with respect to FIG. 26, the system displays different images for various observation categories such as, for example, a plant image 212 for the “Weed” category, an insect image 216 for “Pest” category, a rock image 220 for the “Rock” category, and a skull-and-crossbones image 224 for the “Disease” category. These images are merely examples of a wide variety of different images capable of being displayed by the system on a display of the mobile electronic communication device to uniquely identify observation categories and are not intended to limit the present disclosure. Instead, these examples are merely provided to demonstrate at least some of the principles of the present disclosure and all possible images and manners of identifying observation categories are intended to be within the spirit and scope of the present disclosure.

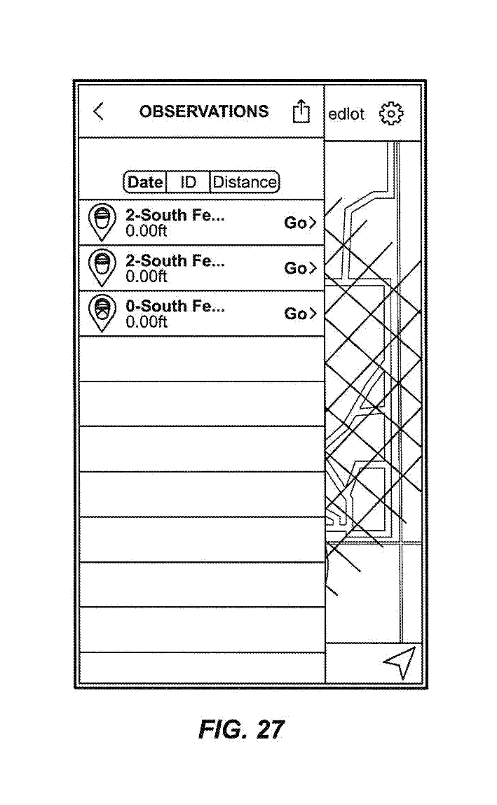

The system is capable of displaying a visual image of a list of the observations 228 made by a user on a display of a mobile electronic communication device. With reference to FIG. 27, one example of a visual image of a list of observations 228 is illustrated. The displayed image 228 contains various details associated with each observation.

In one example, the system is configured to identify a date and time associated with each sample taken by the system, associate the date and time with each sample and store the sample information and/or data with the date and time information and/or data on one or more storage device(s). In this manner, the system is configured to track a performance of the individual(s) performing the samples to ensure efficiency and accuracy.

In one example, the system is configured to generate reports containing information and/or data associated with the soil sampling/testing results. In one example, the system is configured to transmit the reports in a variety of manners including, but not limited to, text, email, electronic transmission to a social media outlet, or any other manner of transmitting information and/or data.

In one example, the system is configured to recognize relationships and patterns for certain agronomic characteristics by zone or portion within a field, farm or land area of interest, use the relationships and patterns to analyze performance of afield, farm or land area of interest and create a specific plan to address the performance. The system is configured to determine the agronomic characteristics tested, where the agronomic characteristics should be tested and when the agronomic characteristics should be tested. The agronomic characteristics may be any agronomic characteristic including, but not limited to, soil properties, plant health, crop yield, climate, topography or any other agronomic characteristics. The system may also take into account time and cost constraints when generating prescriptions, instructions or recommendations for testing agronomic characteristics. The system may generate an agronomic characteristic testing prescription, instructions or recommendation that identifies ideal locations for testing agronomic characteristics, a type of testing, when testing should occur, and provides pathing or directions to the testing locations for a user. After agronomic characteristics have been tested, the system may use the results to validate performance projections and assumptions regarding relationships and patterns associated with agronomic characteristics. The system may provide real or near real time site specific agronomic characteristic management strategies for a zone or portion of a field, farm or land area of interest.

In one example, the system of the present disclosure is configured to include and/or cooperate with the systems, methods and apparatuses disclosed in U.S. patent application Ser. No. 14/749,082, filed Jun. 24, 2015, which is incorporated by reference herein.

In one example, the system of the present disclosure is configured to model patterns and/or relationships between various agronomic characteristics of a zone or portion of a field, farm or land area of interest. The system then may use the patterns and/or relationships to determine the agronomic characteristic(s) that should be tested, where the agronomic characteristic(s) should be tested and when the agronomic characteristic(s) should be tested. The system is capable of performing a wide variety of testing types and methods to test various agronomic characteristics. For example, the system may perform soil testing, tissue testing, crop scouting, in-ground sensing (with, e.g., an in-ground sensor, etc.), remote sensing (with, e.g., one or more sensors mounted on one or more vehicles, an unmanned air vehicle (UAV), a satellite, etc.). As indicated above, the system is configured to test a wide variety of agronomic characteristics including, but not limited to, normalized difference vegetation index (NDVI), plant population, plant stand, plant spacing, biomass, soil moisture, soil water availability, soil temperature, water filtration, organic matter, Leaf Area Index, weather (e.g., solar radiation, temperature (e.g., mean, min, max), precipitation, etc.).

In one example, the system is configured to account for time and/or cost constraints when generating prescriptions, instructions and/or recommendations for testing agronomic characteristics. For example, the system may account for time and/or cost constraints with respect to date, weather, vegetative state, number of people performing tests, cost of testing, etc.

In one example, the system may generate a soil sampling prescription, instruction(s) or recommendation that identifies one or more locations for soil sampling and provide pathing or directions to the one or more soil sampling locations. In one example, the one or more locations may be considered ideal soil sampling locations.

The system may determine soil sampling locations in a wide variety of manners and all possibilities are intended to be within the spirit and scope of the present disclosure. In one example, the system may determine where one or more soil samples should be taken by a nitrogen balance of the soil, which may be based on an amount of nitrogen available for uptake by plants within a zone or portion of afield, farm or land area of interest for a given time frame (e.g., an hour, a day, a week, etc.). The system of the present disclosure may include or cooperate with the systems, methods and apparatuses of U.S. Patent Application No. 62/152,623, filed Apr. 24, 2015, and Ser. No. 15/135,013, filed Apr. 21, 2016, which are incorporated by reference herein. Furthermore, the system of the present disclosure may consider a highest and/or lowest nitrogen balance, when nitrogen is a limiting factor (e.g., limits a performance or yield of a crop), when nitrogen is determined to not be a limiting factor, etc. The system may also determine where sampling locations may be taken using, either instead of nitrogen balance or in addition to nitrogen balance, a relative score for each zone or portion of a field, farm or land area of interest. In one example, the system may account for or consider a wide variety of agronomic characteristics when determining a relative score including, but not limited to, slope of a zone of a land area of interest, size of a zone (e.g., the larger a zone, the easier it is for a user to locate the zone and take a sample using a soil tester), seeding rate, nitrogen balance, etc.

In one example, the system is configured to determine whether new soil sampling locations need to be sampled, soil sample locations from previous growing seasons may be sampled, or a combination of new and previous soil sampling locations may be sampled.

In one example, once the system determines soil sampling locations, the system may generate or determine an optimal number of soil sampling locations to be sampled. In this example, the system may account for or consider time and cost constraints. In one example, the system may generate or determine a frequency of soil sampling. For example, the system determines how frequently soil samples should be taken including, but not limited to, a portion of a day, daily, multiple times weekly, weekly, monthly, or any other frequency. In one example, the system may generate or determine a type of sampling that will occur or will be performed. For example, sampling may be performed for nitrogen, potassium, phosphorous, pH, salinity, etc.

In one example, the system may prescribe or recommend soil sampling locations for a zone or portion of a field, farm or land area of interest for a given day base on nitrogen balance. In one example, the system may direct or send a user to a zone or portion of a field, farm or land area of interest with the highest and/or lowest nitrogen balance on a given day for performing one or more soil samples. In one example, the system may direct or send a user to a zone or portion of a field, farm or land area of interest where nitrogen is a limiting factor and/or where nitrogen is known to not be a limiting factor. In one example, the system may prescribe or recommend soil sampling locations within zones or portions of a field, farm or land area of interest based on nitrogen balance and a relative score. In one example, the relative score may be based on attributes of a certain zone or portion of a field, farm or land area of interest including, but not limited to, slope(s), sizes (e.g., in acres), seeding rates, seed types, etc. Determination of the relative score in this manner allows the relative score to factor in land area of interest attributes to determine an appropriate confidence level. In one example, the system utilizes or relies on slope of a zone or portion of a field, farm or land area of interest to calculate or determine a relative score. In one example, more land area or size and less slope results in a higher relative score, whereas less land area or size and more slope results in a lower relative score. In this manner, the system is capable of comparing one land area of interest against another land area of interest to determine a location for soil sampling. In one example, the location determined for soil sampling may be an optimal location for soil sampling based on the characteristics considered by the system. In one example, the system utilizes or relies on a size of a zone or portion of afield, farm or land area of interest to calculate or determine a relative score. As a size of a land area of interest increases, the easier it becomes for a user to locate the land area of interest and obtain a soil sample. In one example, the system may utilize larger land areas of interest to make it easier for user to find the land areas of interest in order to obtain soil samples.

In one example, the system prescribes or recommends a soil sampling location within a zone or portion of a field, farm or land area of interest. Some zones are irregularly shaped and have centroids positioned outside a boundary of the zone. The system determines a new soil sampling location within the boundary of the zone and directs or instructs the user to the new soil sampling location. In one example, the new soil sampling location may be a position or location within the boundary of the zone nearest the centroid positioned outside the zone.

In one example, the system may determine and prescribe to a user a certain number of soil sample locations at positions within various zones or portions of a field, farm or land area of interest during a growing season and then, during a subsequent growing season, determine and prescribe to a user a different number of soil sample locations within different zones. The system may then analyze the results from multiple growing seasons and determine relationships or patterns between agronomic characteristics at the soil sampling locations within a zone or the zones.

In one example, the system may indicate to a user a desired frequency of collecting soil samples. The system may consider or account for current information or data such as, for example, weather characteristics, and determine if more soil samples are needed. In one example, the system will indicate to a user the prescribed soil sampling locations and an agronomic characteristic that the user should be sampling. For example, the system may instruct a user to sample for nitrogen, potassium, phosphorous, pH, salinity, or any other agronomic characteristic.

In one example, the system may generate remote sensing and imagery prescription that identifies ideal soil sampling locations for remote sensing and imagery, and provides a path or directions, to a user, to these soil sampling locations. In one example, the system may generate a type of soil sampling that will occur and instruct or indicate to a user the type of soil sampling to perform. In one example, NDVI or plant health may be relied upon to generate the remote sensing and imagery prescription.

In one example, after the system tests the soil and associated agronomic characteristics, the system may use test results to validate performance projections and assumptions regarding certain relationships and patterns between agronomic characteristics. In one example, the system compares test results of agronomic characteristics against current projections for those agronomic characteristics. Examples of agronomic characteristics that may be compared or considered include, but are not limited to, a limiting factor of a zone or portion of a field, farm or land area of interest, yield projection(s) of a zone, plant population of a zone, plant stand of a zone, or any other agronomic characteristic. In one example, the system may include a sensor configured to measure plant-by-plant of a zone or portion of a field, farm or land area of interest or the entire field, farm or land area of interest. One example of such a sensor is disclosed in U.S. Patent Application No. 62/149,211, filed Apr. 17, 2015, and Ser. No. 15/099,793, filed Apr. 15, 2016, which are incorporated by reference herein. For example, if a user set his planter to plant seeds at a seeding rate of 32,000 seeds per acre, the system can confirm, with the sensor, an actual plant population and compare the actual plant population against the seeding rate and/or a planter monitor of a planter (some planters include monitors that display what was actually planted using sensors on seed tubes of each row unit of a planter).

In one example, the system compares soil test results associated with agronomic characteristics against projections established from previous growing seasons for those agronomic characteristics. For example, test results may be compared based on agronomic characteristics including, but not limited to, nitrogen results, NDVI, plant population, etc. In one example, if test results associated with nitrogen differs from projections, the system may propose a modification to be made. For example, the system may propose adjusting nitrogen balance, adjusting C:N ratio, adjusting yield projection for the present growing season depending upon difference between a measured nitrogen level and a projected nitrogen level, adjusting yield projection for future growing seasons.

In one example, the system is configured to sense or identify pest infestation and/or plant disease. In one example, the system utilizes remote sensing and/or imaging to detect areas of pest infestation and/or plant disease. In one example, the system is configured to update or alter assumptions and/or projections based on impact of pests and/or disease. In one example, the system is configured to adjust or alter crop yield projections for current season based on impact of pests and/or disease. In one example, if pests and/or disease is persistent or recurring, the system is configured to adjust or alter crop yield projections for future season(s).

In one example, the system is configured to provide real- or near real-time site specific agronomic characteristic management strategies for one or more zones or portions of a field, farm or land area of interest. In one example, the system is configured to generate or create one or more of a fertilizer prescription or recommendation for a user to apply fertilizer, a pesticide prescription or recommendation for a user to apply pesticide, a herbicide prescription or recommendation for a user to apply herbicide, etc. In one example, the system is configured to generate or create a planting prescription or recommendation for a user to plant a crop. In one example, if the system determines a soil test result has lower nitrogen than projected, the system may adjust a nitrogen balance, adjust a C:N ratio, adjust the crop yield downward depending on difference between measured nitrogen and projected nitrogen, and/or generate a prescription or recommendation instructing a user to apply more nitrogen. In one example, if the system determines, via remote sensing and/or image detection, presence of a pest infestation, the system identifies a type of pest, adjusts a crop yield projection and/or generates a prescription or recommendation instructing a user to apply a pesticide. In one example, if the system performs a remote sensing look-ahead, the system identifies one or more relationship(s) and/or pattern(s) within a zone or portion of a field, farm or land area of interest, tests one or more agronomic characteristics, validates the one or more relationship(s) and/or pattern(s) within the zone or portion of a field, farm or land area of interest, relies on the one or more relationship(s) and/or pattern(s) to address time lag problem for a remote sensor. In another example, this look-ahead capability may be performed by the systems and apparatuses disclosed in U.S. Provisional Patent Application No. 62/149,211, filed April 17, and Ser. No. 15/099,793, filed Apr. 15, 2016, referenced and incorporated by reference above. For example, a sensor mounted on an agricultural device such as, for example, a sprayer, cannot both sense what is happening and adjust application rate simultaneously. The sensor requires look-ahead capabilities. The validated relationships and/or patterns assist with providing the look-ahead.

In one example, the system is configured to recognize relationships and/or patterns for certain agronomic characteristics by zone within a field, use the relationships and/or patterns to analyze a performance of the field, and create a specific plan to address the performance. The system may determine what agronomic characteristics are tested, where the tests should occur and when the tests should occur. The agronomic characteristics may relate to a wide variety of agronomic characteristics including, but not limited to, soil properties, plant health, crop yield, climate, topography, among others. In one example, the system may consider time and cost constraints when generating prescriptions for testing agronomic characteristics. In one example, the system may generate an agronomic characteristics testing prescription that identifies ideal locations for testing agronomic characteristics, the type of testing, when the testing should occur and provides pathing or directions to the soil sampling locations. In one example, the system may use the results of the soil tests to validate performance projections and assumptions regarding certain relationships and patterns. In one example, the system may provide real or near real-time side specific agronomic characteristic management strategies for a zone or zones of a field.

In one example, the system is configured to cluster or group zones or portions of a field, farm or land area of interest based on one or more agronomic similarities. Agronomic similarities may be any type and any quantity of agronomic characteristics. For example, the system may compare a single agronomic characteristic for all zones or portions of a field, farm or land area of interest and group the zones based on how similar the agronomic characteristic is between zones. Also, for example, the system may compare a plurality of agronomic characteristics for all zones or portions of a field, farm or land area of interest and group the zones based on how similar the agronomic characteristics are between zones. The system is capable of considering any agronomic characteristic, any quantity of agronomic characteristics, and in any combination of agronomic characteristics and all of such possibilities are intended to be within the spirit and scope of the present disclosure. For example, agronomic characteristics that may be considered and relied upon to cluster or group the zones include, but are not limited to, tillage practices, drainage, irrigation, seed traits, seed population, row width, vegetative state, sunlight, soil properties, nutrient uptake, micronutrient uptake, organic matter, root room, aeration, soil temperature, soil moisture, soil moisture capacity, cation exchange capacity, soil pH, historical weather, plant moisture, water quality, slope of land area, as applied planting data, historical planting data, historical yield data, as applied fertilizer data, historical fertilizer data, historical weather data, current weather data, pests, diseases, weeds, economic data, planting date, row width, seed traits, seed population, soil properties, nutrient uptake, organic matter, a soil sample, historical weather data and current weather data or any other agronomic characteristic.

The system is also configured to cluster or group the zones into any quantity of clusters or zone. For example, the system may cluster or group the zones into as few as two groups and as many groups as the number of zones in a field, farm or land area of interest (i.e., each zone could be its own group). The system may cluster or group the zones into groups for a variety of reasons including, but not limited to, facilitating more efficient and accurate soil testing by decreasing the number of soil test that must be conducted (the user may not need to test every zone in the same group, rather the user may test less than all the zones in a similar group since the grouped zones have similar agronomic characteristics and are likely to provide the same or similar soil test results), decreasing a number of overall zones that may require soil testing by combining like or similar zones into a similar group or zone (in this example, boundary lines separating zones within a same group may be removed to provide a larger zone, thereby presenting a single larger zone for a user to test rather than testing each of the individual zones—this also makes it easier for a user to find a larger zone and test within the zone), among other reasons.

The system may cluster or group the zones in a variety of different manners and all of such possibilities are intended to be within the spirit and scope of the present disclosure. In one example, the system relies on cluster analysis to cluster or group the zones. In one example, the system relies on k-means cluster analysis. Cluster analysis may include assignment of a set of observations into clusters or groups so that observations in the same group or cluster are similar in some manner. Appropriate metrics and a linkage criterion that determine how clusters are formed based on a distance between objects or a similarity in agronomic characteristics are used.

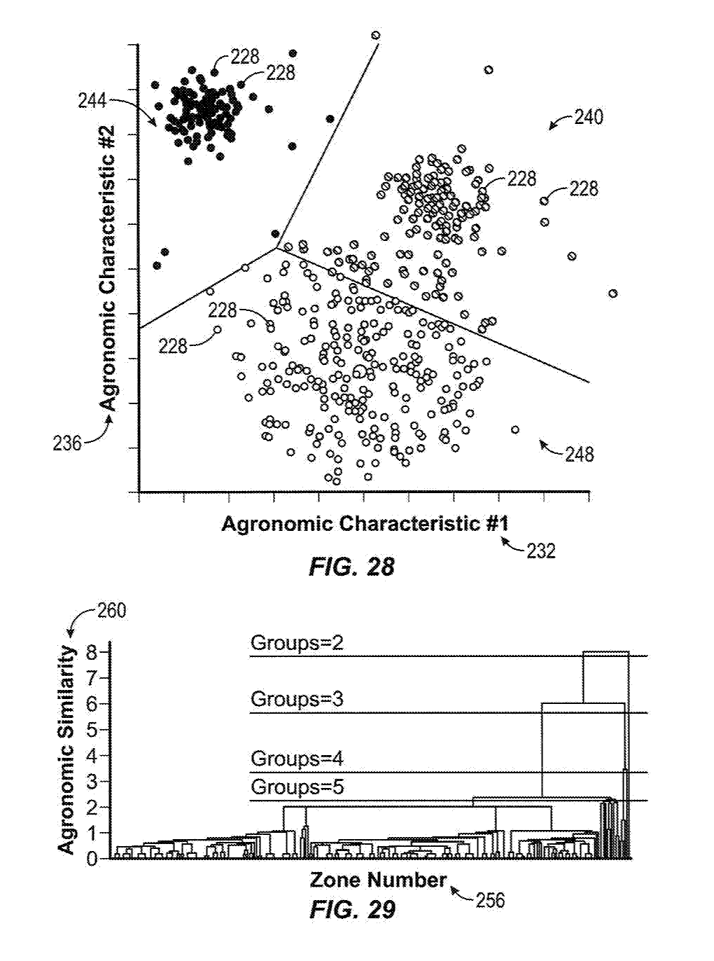

With reference to FIGS. 28-30, one example of the system clustering or grouping zones of a field, farm or land area of interest is illustrated. The following example of the system and the example of clustering or grouping the zones is provided as one example of many possible examples and is provided to demonstrate principles of the present disclosure. The following examples should not be limiting upon the present disclosure.

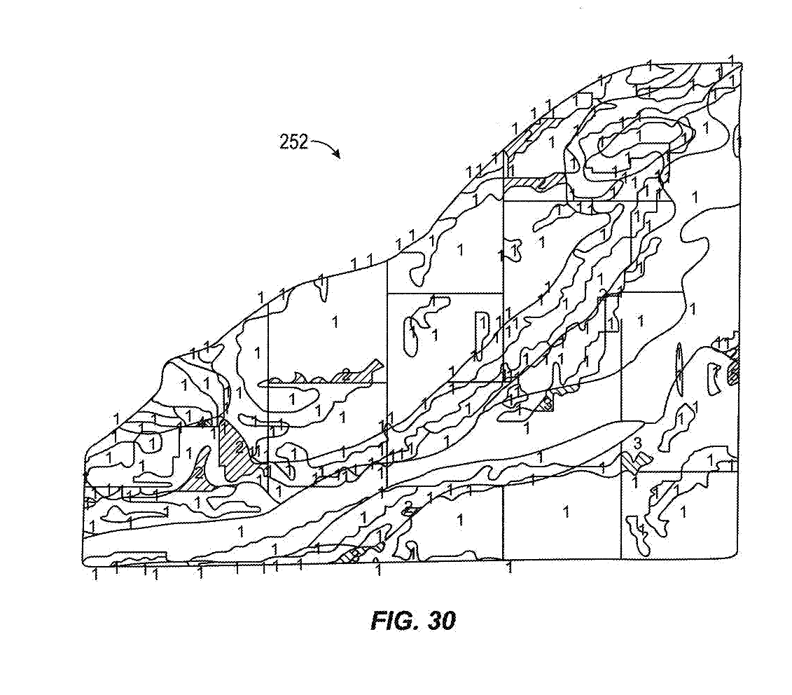

In this example, the system will consider two agronomic characteristics, determine similarities between the zones of the field, farm or land area of interest based on the two agronomic characteristics, and group or cluster the zones based on the similarities. With reference to FIG. 28, each zone of the field, farm or land area of interest is represented by a dot or point 228 on the graph or plot. A first agronomic characteristic 232 is represented on a first axis or x-axis and a second agronomic characteristic 236 is represented on a second axis or y-axis. The system positions the points 228 associated with the zones on the graph based on their relationship with both the first and second agronomic characteristics 232, 236. In this example, the system is clustering or grouping the zones into three groups or clusters 240, 244, 248. In one example, the system determines the quantity of groups or zones. In another example, a user may select or determine the quantity of groups or zones and input the quantity of groups or zones into the system via one or more input devices on an electronic device, such as, for example, a mobile electronic communication device. Once the system determines which group 240, 244, 248 the zones go into, the system may output the information to a user in a variety of different manners. In one example, the system may output the grouping information or data in a spreadsheet form. In one example, the system may output the grouping information or data in a visual format 252 such as, for example, a color-coded map, which identifies the different groups with different colors. The visual format may be displayed on a display of an electronic device, such as, for example a mobile electronic communication device. One example of a color coded map is illustrated in FIG. 30; however, FIG. 30 is based on the system grouping or clustering the zones into five groups instead of three. A color coded map corresponding to the graph illustrated in FIG. 28 would only include three different colors representing the three groups or clusters of zones.

Referring now to FIG. 29, another example of organizing the plurality of zones to determine a group or cluster is illustrated. In this example, the plurality of zones 256 are represented on a first axis or x-axis and agronomic similarity 260 is represented on a second axis or y-axis. A height of a bar or connection line between zones is based on a quantity of agronomic similarity between the zones. In this example, the system groups or clusters the zones into five groups or clusters. In FIG. 29, the system establishes group thresholds and the position of the bars associated with the zones determine in which group the zones will be grouped or clustered. Once the system groups or clusters the zones, the system may output the information or data associated with the grouped zones in a wide variety of manners. In one example, the system outputs the information or data in a visual format such as, a color coded map of the field, farm or land area of interest, such as the map in FIG. 30.

It should also be understood that words like transmit, communicate, receive, retrieve, obtain, etc., used with respect to data transfers are not intended to be restrictive to a particular manner in which data is transferred between two elements. That is, these and other words do not imply a pushing or pulling requirement of the data between two elements. Rather, the present disclosure intends that data may be transferred between two elements in any manner and all of such possibilities are intended to be within the spirit and scope of the present disclosure.

It should also be understood that any feature, function, process, and/or method of the present disclosure may be customizable by a user and all of such customization is intended to be within the spirit and scope of the present disclosure. For example, zones and/or slopes may be customized by a user as desired.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the systems, methods, processes, apparatuses and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the systems, apparatuses, devices, methods and/or processes via the use of block diagrams, schematics, flowcharts, and/or examples. Insofar as such block diagrams, schematics, flowcharts, and/or examples contain one or more functions and/or operations, it will be understood by those within the art that each function and/or operation within such block diagrams, schematics, flowcharts, or examples can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

Information and/or data may be input into the system using various components in a variety of manners. In one example, the system and components of the system may include one or more input devices. Alternatively, it should be understood that the system may include components that allow information and/or data to be input in different manners such as, for example, by a user performing a gesture. In such an example, a component worn by the user or a component to which the user moves into proximity may include a sensor, probe or accelerometer to sense or identify a gesture performed by the user. The system identifies the gesture, associates the gesture with particular information and/or data, and acts in accordance with the information and/or data associated with the gesture. In other examples, the system may include one or more sensors configured to transmit information and/or data associated with an event. When the event occurs, the sensor transmits information and/or data and the system acts in accordance with the transmitted information and/or data. The type of information and/or data input into the system in various manners may pertain to information requested of the user, soil samples and tests, or any other type of information and/or data that is input into the system.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

Unless specifically stated otherwise or as apparent from the description herein, it is appreciated that throughout the present disclosure, discussions utilizing terms such as “accessing,” “aggregating,” “analyzing,” “applying,” “brokering,” “calibrating,” “checking,” “combining,” “comparing,” “conveying,” “converting,” “correlating,” “creating,” “defining,” “deriving,” “detecting,” “disabling,” “determining,” “enabling,” “estimating,” “filtering,” “finding,” “generating,” “identifying,” “incorporating,” “initiating,” “locating,” “modifying,” “obtaining,” “outputting,” “predicting,” “receiving,” “reporting,” “sending,” “sensing,” “storing,” “transforming,” “updating,” “using,” “validating,” or the like, or other conjugation forms of these terms and like terms, refer to the actions and processes of a computer system or computing element (or portion thereof) such as, but not limited to one or more or some combination of: a visual organizer system, a request generator, an Internet coupled computing device, a computer server, etc. In one example, the computer system and/or the computing element may manipulate and transform information and/or data represented as physical (electronic) quantities within the computer system's and/or computing element's processor(s), register(s), and/or memory(ies) into other data similarly represented as physical quantities within the computer system's and/or computing element's memory(ies), register(s) and/or other such information storage, processing, transmission, and/or display components of the computer system(s), computing element(s) and/or other electronic computing device(s). Under the direction of computer-readable instructions, the computer system(s) and/or computing element(s) may carry out operations of one or more of the processes, methods and/or functionalities of the present disclosure.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

It should be understood that the present disclosure includes various examples, embodiments, and/or applications, and the structural components and/or functionalities/operations thereof may be solely associated with their respective examples, embodiments, and/or applications or they may be combined, in whole or in part, with one or more other examples, embodiments and/or applications in any combination.

Although the present disclosure has been described in terms of specific examples, embodiments or applications, persons skilled in the art can, in light of this teaching, generate additional examples, embodiments or applications without exceeding the scope or departing from the spirit of the present disclosure described herein. Accordingly, it is to be understood that the drawings and description in this disclosure are proffered to facilitate comprehension of the present disclosure, and should not be construed to limit the scope thereof.

1. A method of sampling soil, the method comprising:
determining a soil sampling location in a land area of interest by using, at least in part, an electronic device;
displaying a first visual image associated with the soil sampling location on a display of the electronic device;
navigating to the soil sampling location with the electronic device;
sampling soil at the soil sampling location with a soil tester; and
displaying a second visual image on the display of the electronic device associated with a result obtained from the soil sample.

2. The method of claim 1, wherein the electronic device is a mobile electronic communication device and the display is a display of the mobile electronic communication device.

3. The method of claim 1, further comprising indicating arrival at the soil sampling location with the electronic device.

4. The method of claim 3, wherein indicating further comprises providing, with the electronic device, at least one of an audible indication and a visual indication.

5. The method of claim 1, further comprising relying on the result obtained from the soil sample to provide an agricultural prescription.

6. The method of claim 5, wherein the agricultural prescription is comprised of at least one agricultural action to be taken associated with at least one agricultural characteristic.

7. The method of claim 5, wherein the agricultural prescription is comprised of at least one of a soil sampling location, a type of soil sampling to be performed, a time to perform soil sampling and directions to a soil sampling location.

8. The method of claim 5, wherein the agricultural prescription is comprised of a soil sampling location, a type of soil sampling to be performed, a time to perform soil sampling and directions to a soil sampling location.

9. The method of claim 1, further comprising communicating data associated with the soil sample from the soil tester to the electronic device.

10. The method of claim 9, wherein communicating further comprises communicating the data over at least one network to the electronic device.

11. The method of claim 1, wherein determining a soil sampling location further comprises determining a soil sampling location by using, at least in part, an electronic device based on historical data.

12. The method of claim 1, wherein determining a soil sampling location further comprises displaying a grid visual image on the display of the electronic device overlaid over a visual image of the land area of interest, wherein the grid visual image includes a plurality of cells with one of the cells representing the soil sampling location.

13. The method of claim 12, wherein determining a soil sampling location further comprises determining a plurality of soil sampling locations in the land area of interest by using, at least in part, the electronic device, wherein each of the plurality of cells represents one of the plurality of soil sampling locations.

14. The method of claim 12, further comprising adjusting at least one of a size of the plurality of cells of the grid visual image and an orientation of the grid visual image relative to the visual image of the land area of interest with the electronic device.

15. The method of claim 14, further comprising adjusting a size of the plurality of cells of the grid visual image with at least one first input device of the electronic device and adjusting an orientation of the grid visual image relative to the visual image of the land area of interest with at least one second input device of the electronic device.

16. The method of claim 12, further comprising indicating arrival at the soil sampling location with the electronic device when the electronic device is geographically located within the one of the cells representing the soil sampling location.

17. The method of claim 1, wherein determining a soil sampling location further comprises determining a plurality of soil sampling locations in the land area of interest by using, at least in part, the electronic device, and wherein navigating further comprises navigating to the one of the plurality of soil sampling locations that is geographically closest to the electronic device.

18. The method of claim 1, wherein navigating further comprises displaying at least one of a visual image of a direction toward the soil sampling location and a visual image of a distance to the soil sampling location on the display of the electronic device.

19. The method of claim 18, further comprising displaying both the visual image of the direction and the visual image of the distance on the display of the electronic device.

20. The method of claim 1, further comprising inputting data associated with an observation made in the land area of interest into the electronic device, wherein the observation is associated with at least one of a weed, a pest, a rock and a disease.
